(19) United States
(12) Patent Application Publication
(10) Pub. No.: US 2017/0335220 A1
(43) Pub. Date: Nov. 23, 2017

(54) WATER-BASED COMPOSITION COMPRISING A FLUORINATED POLYMER

(71) Applicant: SOLVAY SPECIALTY POLYMERS ITALY S.P.A., Bollate (IT)

(72) Inventors: Patrizia MACCONE, Milano (IT); Sara ROVINETTI, Garbagnate Milanese (IT); Gianfranco SPATARO, Lissone (IT); Marco BELTRAMIN, Senago (IT)

(21) Appl. No.: 15/535,399

(22) PCT Filed: Dec. 14, 2015
(86) PCT No.: PCT/EP2015/079525

§ 371 Date: Jun. 12, 2017

(30) Foreign Application Priority Data
Dec. 15, 2014 (EP) 14197845.2

(51) Int. Cl. C10M 107/38; C08L 71/02

(52) U.S. Cl. CPC C10M 107/38; C08L 71/02; C08L 2201/54; C10M 2213/062; C10M 2213/043

(57) ABSTRACT

This invention provides for a composition particularly useful in a method comprising applying the composition to a surface to be lubricated, said composition comprising: at least one polymer (P) comprising a partially or fully fluorinated, straight or branched, polyoxyalkylene chain (R_{f}) having two chain ends, wherein one or both chain end(s) bear(s) a hydroxy-, alkoxy- or acyl-oxy-terminated polyoxyalkylene chain free from fluorine atoms (Rₐ), said chain comprising from 4 to 50 fluorine-free oxyalkylene units, said units being the same or different from one another and being selected from —CH₂CH₂O— and —CH₂CH(O)O—, wherein J is independently straight or branched alkyl or aryl, preferably methyl, ethyl or phenyl and water.

### CROSS REFERENCE TO RELATED APPLICATION

This application claims priority from European application No. 14197845.2, filed on 15 Dec. 2014, the whole content of this application being incorporated herein by reference for all purposes.

### TECHNICAL FIELD

The present invention relates to a water-based composition comprising a fluorinated polymer, to a method for the manufacture of the composition and to a lubrication method comprising applying said composition to a surface to be lubricated.

### BACKGROUND ART

Polyoxyalkylene glycols (in the following referred to as “PAGs”) are used in a variety of applications, such as the lubrication of gears, transmission systems, air conditioning (NC) systems, metalworking fluids as well as hydraulic fluids. For this purpose, PAGs can be formulated as aqueous or non-aqueous compositions containing specific additive packages to improve their performances. However, it has been observed that, when PAGs are used as base oils in such compositions, they do not provide satisfactory performances for applications requiring harsh conditions, such as high temperatures and extreme friction conditions.

(Per)fluoropolyethers (in the following referred to as “PFPEs”) are fluorinated polymers comprising a fully or partially fluorinated polyoxyalkylene chain (herein after “chain R_{f}”) that contains recurring units having at least one catenary ether bond and at least one fluorocarbon moiety. PFPEs have been also long since known as base oils or as additives in several lubricant applications and they are endowed with outstanding performances under harsh conditions. However, PFPEs are not soluble in water; therefore, they are typically used in the form of compositions with organic solvents, preferably fluorinated solvents or, in order to be used in water, they require the use of surfactants or of special dispersing agents. However, certain materials, for example plastics, do not withstand organic solvents: therefore, any surface-treating agent or lubricant needs to be applied thereto in the form of water-based compositions, with reduced amounts of organic solvents or with no organic solvents at all.

Modified PFPE lubricants comprising a chain R_{f} having two ends, wherein one or both end comprises one or more terminal (poly)oxyalkylene units free from fluorine atoms are known in the art.

For example, patent document U.S. Pat. No. 7,230,140 (ASAHI GLASS COMPANY, LIMITED) 8 Sep. 2005 discloses a PFPE derivative of the formula (I):

HO—(CH₂CH₂O)ᵣ(CH₂CH(OH)CH₂O)ₚ—CH₂CF₂O(CF₂CF₂O)ₘCF₂CH₂O—(CH₂CH(OH)CH₂O)_{q}(CH₂CH₂O)ₛ—H (I)

wherein:

m is an integer of from 3 to 200,

each of r and s, which are independent of each other, and is an integer of from 0 to 100, and each of p and q, which are independent of each other and, is an integer of from 0 to 100.This derivative is said to be useful as lubricating oil or as coating agent and is said to be less likely to undergo decomposition, and to be free from deterioration during its use. It is worth noting that the PFPE backbone of the derivative of formula (I) comprises only —CF₂CF₂O— repeating units; indeed, in this document it is stated that PFPE derivatives comprising also —CF₂O— units further contain —OCF₂O— units that may cause decomposition or deterioration (reference is made to col. 1, lines 21-25).

Thus, this prior art document teaches to improve the stability of PFPE lubricants by selecting a PFPE chain without —CF₂O— units. The description discloses in particular a preferred compound of formula:

HO(CH₂CH₂O)ᵣCH₂CF₂O(CF₂CF₂O)ₘCF₂CH₂O(CH₂CH₂O)ₛH (Ic)

wherein r and s are simultaneously 1

and a compound of formula:

HO(CH₂CH(OH)CH₂O)ₚCH₂CF₂O(CF₂CF₂O)ₘCF₂CH₂O(CH₂CH(OH)CH₂O)_{q}H (Id)

wherein p and q are simultaneously 1. Examples 6-1, 6-2 and 7 illustrate the synthesis of certain compounds complying with formulae (Ic) and (Id) above. Nevertheless, this document does not teach to prepare compounds complying formula (I) having r and s higher than 1. Moreover, this document teaches to use a solution of a derivative of formula (I) preferably in an organic solvent (col 6, lines 66 to col 7, line 46), without giving any hint or suggestion to the use of water as solvent.

US 2006252910 A (ASAHI, GLASS COMPANY, LIMITED) 9 Nov. 2006 relates to fluoropolyether compounds complying with formula (A) below:

(X—)ₓY(—Z)_{z} (A)

wherein:
X is a group represented by the following formula (X):

HO—(CH₂CH₂O)ₐ(CH₂CH(OH)CH₂O)_{b}—(CH₂)_{c}—CF₂O(CF₂CF₂O)_{d}— (X)

wherein a is an integer of from 0 to 100, b is an integer of from 0 to 100, c is an integer of from 1 to 100, and d is an integer of from 1 to 200;
Z is a group represented by the following formula (Z):

R^{F}O(CF₂CF₂O)_{g}— (Z)

wherein R^{F} is a C₁₋₂₀ perfluoroalkyl group or a group having an etheric oxygen atom inserted between carbon-carbon atoms of such a perfluoroalkyl group (the group has no —OCF₂O— structure), and g is an integer of from 3 to 200;
Y is a (x+z) valent perfluorinated saturated hydrocarbon group, or a (x+z) valent perfluorinated saturated hydrocarbon group having an etheric oxygen atom inserted between carbon-carbon atoms, having no —OCF₂O— structure;
X, Z: x is an integer of at least 2, z is an integer of at least 0, and (x+z) is an integer of from 3 to 20, provided that when x is at least 2, groups represented by the formula (X) may be the same or different, and when z is at least 2, groups represented by the formula (Z) may be the same or different (reference is made in particular to [0015]-[0019]). This document teaches that fluoropolyether compounds (A) are useful, inter alia, as lubricants, especially in the form of solutions with organic solvents (reference is made in particular to par. [0013] and [0024]), and that they are less subject to deterioration, as they do not contain —OCF₂O— units in their molecular structure. Indeed, in formula (A), group Y is an at least trivalent group which does not contain —OCF₂O— units. Thus, this document teaches away from PFPE lubricants comprising —CF₂O— repeating units. In addition, this prior art does not teach to synthesise fluoropolyether compounds having more than one ethoxylated units in the chain ends.

US 2008132664 A (ASAHI GLASS COMPLANY, LIMITED) 5 Jun. 2008 relates to an ether composition comprising a polyether compound (A) and an ether compound (B), said composition being useful, inter alia, as lubricant (see par. [0007] and [0025]). Examples of ether compounds (B) comply with formulae (B-4) and (B-5) below:

HOCH₂CH(OH)CH₂OCH₂CF₂O(CF₂CF₂O)_{d7}(CF₂O)_{g2}CF₂CH₂OCH₂CH(OH)CH₂OH (B-4)

HOCH₂CH₂OCH₂CF₂O(CF₂CF₂O)_{d8}(CF₂O)_{g3}CF₂CH₂OCH₂CH₂OH. (B-5)

In formula (B-4), d7 is a positive number of at least 1, g2 is a positive number of at least 0, and the average molecular weight of the compound represented by formula (B-4) is from 500 to2,000;

In formula (B-5), d8 is a positive number of at least 1, g3 is a positive number of at least 0, and the average molecular weight of the compound represented by the formula (B-5) is from 500 to 2, 000.

It is worth noting that polyether compound (A) contains at least two —CF₂ CF₂O— units and does not contain —OCF₂O— units and that this document teaches that high chemical stability can be achieved thanks to the presence of such compound (A). Furthermore, compound (B-4) comprise only one —OCH₂CH(OH)CH₂— unit at each end of the PFPE chain, while compound (B-5) comprises only one —OCH₂CH₂— unit at each chain end of the PFPE chain. When the ether composition is used as lubricant, it is preferably used as a solution, preferably in a commercially available solvent. Fluorinated solvents and perfluoroalkylamines are said to be preferred (reference is made in particular to par. [0059]). Water is neither mentioned nor suggested as solvent.

U.S. Pat. No. 3,810,874 A (MINESOTA MINING AND MANUFACTURING COMPANY) 15 May 1974 discloses linear polyfunctional-terminated poly(perfluoroalkyleneoxide) compounds of formula:

A-[CF₂—O—(CF₂CF₂O)ₘ—(CF₂O)ₙ1'CF₂]A′

wherein A or A′ could be —CH₂OH, or —CH₂OCH₂CH(OH)CH₂OH; and the ratio m/n is 0.2/1 to 5/1, preferably 0.5/1 to 2/1. These compounds are said to be suitable for use as lubricants and as viscosity index additives for perhalogenated lubricants. However, this document does not disclose or suggest PFPE derivatives bearing a plurality of oxyalkylene end units at each end of the PFPE chain. Furthermore, this document does not provide any teaching on specific formulations, e.g. solutions.

EP 0826714 A (AUSIMONT S.P.A.) discloses a method for the water removal from a surface, which comprises covering the surface with a composition having specific weight higher than that of water, and subsequently removing water from the composition by skimming. (Per)fluoropolyether polymers comprising 3 or 5 oxyalkylene units at one of their chain end (i.e. they are monofunctional polymers) are disclosed in the examples, but they are never disclosed within water compositions, as they are rather obtained within the organic phase. In other words, this document does not disclose water-based compositions comprising (per)fluoropolyether polymers.

It would thus be desirable to provide modified PFPEs suitable for use in aqueous-based compositions. It would also be desirable to provide water-based compositions comprising PFPEs having better lubrication properties with respect to PAGs.

### SUMMARY OF INVENTION

The Applicant has now found out that polymers [polymers (P)] comprising a (per)fluoropolyether chain having two chain ends, wherein one or both chain ends bear a definite number of oxyalkylene units free from fluorine atoms are soluble in water, even without addition of other surfactants. The Applicant has also found out that such polymers show improved lubrication properties (such as lower wear), higher thermal stability, and improved performances at extreme pressures with respect to PAGs.

Accordingly, the present invention relates to a composition [composition (C)] comprising at least one polymer (P) and water and to a lubrication method comprising treating a surface to be lubricated with composition (C).

Polymers (P) for use in composition (C) will be herein after also generically referred to as “PFPE-PAGs” and, more specifically, as “mono- or bi-functional” PFPE-PAGs, depending on whether one or both chain ends bear a chain Rₐ.

General definitions, symbols and abbreviations

For the purposes of the present description:
the term “(per)fluoropolyether” stands for “fully or partially fluorinated polyether”;
the acronym PFPE(s) stands for (per)fluoropolyether(s);
the use of parentheses “( . . . )” before and after symbols or numbers identifying compounds, chemical formulae or parts of formulae, has the mere purpose of better distinguishing those symbols or numbers from the rest of the text; thus, said parentheses could also be omitted. For example, “chain (R_{f})” is equivalent to “chain R_{f}”;
a monofunctional PFPE is a polymer comprising a PFPE chain having two ends, one end comprising one or more functional groups and the other end terminating with a (per)haloalkyl group, i.e. a fully or partially halogenated hydrocarbon group wherein one or more hydrogens is replaced by one or more halogen atoms, preferably fluorine atoms;
a bifunctional PFPE is a polymer comprising a PFPE chain having two ends, each end comprising one or more functional groups;
the term “(halo)alkyl” denotes a hydrocarbon group wherein one or more hydrogens can be replaced by one or more halogen atoms, preferably fluorine atoms;
the terms “aromatic” and “aryl” mean any cyclic moiety having a number of π electrons equal to 4n+2, wherein n is 0 or any positive integer;
the indefinite article “a” stands for “one or more”, unless indicated otherwise. Substantives in the plural form are to be construed as including also the singular form, i.e. as “one or more”, unless indicated otherwise.

For example, the term “compounds” is to be construed as referring to a single compound or to “one or more compounds”, unless indicated otherwise;
when ranges are indicated, range extremes are included.

### Polymers (P)

Polymers (P) for use in composition (C) comprise a partially or fully fluorinated, straight or branched, polyoxyalkylene chain (chain R_{f}) having two chain ends, wherein one or both chain end(s) bear(s) a hydroxy-, alkoxy- or acyloxy- terminated polyoxyalkylene chain free from fluorine atoms (chain Rₐ), said chain comprising from 4 to 50 fluorine-free oxyalkylene units, said units being the same or different from one another and being selected from —CH₂CH₂O— and —CH₂CH(J)O—, wherein J is independently straight or branched alkyl or aryl, preferably methyl, ethyl or phenyl.

Typically, the PFPE-PAGs for use in the method of the invention comply with formula (I) below:

A-O—R_{f}—(CF₂)ₓ—CFZ—CH₂—O—Rₐ (I)

wherein:
R_{f} is a (per)fluoropolyoxyalkylene chain having an average number molecular weight Mₙ ranging from 100 to 8,000, preferably from 300 to 6,000, more preferably from 800 to 3,000, and comprising, preferably consisting of, repeating units, which may be equal to or different from one another, selected from:
(i) —CFXO—, wherein X is F or CF₃,
(ii) —CFXCFXO—, wherein X, equal or different at each occurrence, is F or CF₃, with the proviso that at least one of X is F;
(iii) —CF₂CF₂CW₂O—, wherein each of W, equal or different from each other, are F, Cl, H;
(iv) —CF₂CF₂CF₂CF₂O—;
(v) —(CF₂)ⱼ-CFZ—O— wherein j is an integer from 0 to 3 and Z is a group of general formula —OR_{f}′T, wherein R_{f}′ is a fluoropolyoxyalkene chain comprising a number of repeating units from 0 to 10, said recurring units being chosen among the followings: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group;
Z is fluorine or CF₃;
x is 0 or 1, with the proviso that, when, x is 1, Z is F;
A is —(CF₂)ₓ—CFZ—CH₂—O—Rₐ, wherein x and Z are as defined above, or is a straight or branched C₁-C₄ perfluoroalkyl group wherein one fluorine atom can be substituted by one chlorine atom or one hydrogen atom, with the proviso that, if chlorine is present in group A, it is in a molar amount lower than 2% with respect to the overall amount of end groups and
Rₐ is a hydroxy-, alkoxy- or acyloxy- terminated polyoxyalkylene chain free from fluorine atoms (chain Rₐ), said chain comprising from 4 to 50 fluorine-free oxyalkylene units, said units being the same or different from one another and being selected from —CH₂CH₂O— and —CH₂CH(J)O—, wherein J is as defined above.

Preferred R_{f} chains in the PFPE-PAGs of formula (I) are those selected from formulae (a)-(c) here below:

—(CF₂O)ₙ(CF₂CF₂O)ₘ(CF₂CF₂CF₂O)ₚ(CF₂CF₂CF₂CF₂O)_{q}— (a)

wherein m, n, p, q are selected from 0 and integers in such a way as chain R_{f} meets the above number average molecular weight requirement; when m is other than 0, the m/n ratio is preferably between 0.1 and 20; when (m+n) is other than 0, (p+q)/(m+n) is preferably between 0 and 0.2;

—(CF₂CF(CF₃)O)ₐ(CF₂CF₂O)_{b}(CF₂O)_{c}(CF(CF₃)O)_{d}— (b)

wherein a, b, c, d are selected from 0 and integers in such a way as chain R_{f} meets the above number average molecular weight requirement; with the proviso that, at least one of a, c and d is not 0; when b is other than 0, a/b is preferably between 0.1 and 10; when (a+b) is different from 0 (c+d)/(a+b) preferably is between 0.01 and 0.5, more preferably between 0.01 and 0.2;

—(CF₂CF(CF₃)O)ₑ(CF₂O)_{f}(CF(CF₃)O)_{g}— (c)

wherein e, f, g are selected from 0 and integers in such a way as chain R_{f} meets the above number average molecular weight requirement; when e is other than 0, (f+g)/e is preferably between 0.01 and 0.5, more preferably between 0.01 and 0.2.

PFPE-PAGs of formula (I) wherein chain R_{f} complies with formula (a) as defined above are particularly preferred in the method of the invention.

Typically, in the PFPE-PAGs of formula (I), chain Rₐ complies with formula (Rₐ—I) below:

—(CH₂CH₂O)ᵣ(CH₂CH(CH₃)O)ₛ(CH₂CH(CH₂CH₃)O)ₜ(CH₂CH(Ph)O)ᵤR¹ (Rₐ—I)

wherein r, s, t and u are independently selected from 0 and a positive number, with r+s+t+u ranging from 4 to 50, preferably from 4 to 30, more preferably from 4 to 15, and R¹ is selected from hydrogen, C₁-C₄ straight or branched alkyl, preferably methyl, and —C(O)R², wherein R² is C₁-C₄ straight or branched (halo)alkyl.

In one preferred embodiment, in chain (Rₐ—I), r is a positive number ranging from 4 to 30, preferably from 4 to 15, s, t and u are 0 and R¹ is hydrogen or methyl.

In another preferred embodiment, r, t and u are 0, s is a positive number ranging from 4 to 30, preferably from 4 to 15, and R¹ is hydrogen or methyl.

In another preferred embodiment, r and s are positive numbers and t and u are 0, r+s ranges from 4 to 30, preferably from 4 to 15, and R¹ is hydrogen or methyl. In the present invention, this embodiment is particularly preferred.

When two or more of the —CH₂CH₂O—, —CH₂CH(CH₃)O—, —CH₂CH(CH₂CH₃) O— and —CH₂CH(Ph)O— units are present in chain (Rₐ—I), they can be arranged in blocks or they can be disposed at random.

According to one preferred embodiment, the PFPE-PAGs are bifunctional PFPE-PAGs complying with formula (I-A) below:

Rₐ—O—CH₂—CF₂—O—R_{f}—CF₂—CH₂—O—Rₐ (I-A)

wherein:
Rₐ is as defined above and
R_{f} complies with formula (a) as defined above.

According to a preferred embodiment, bifunctional PFPE-PAGs for use according to the present invention have an average functionality (F) of at least 1.50, preferably of at least 1.80.

Average functionality (F) represents the average number of functional groups per polymer molecule and can be calculated according to methods known in the art, for example as disclosed in EP 1810987 A (SOLVAY SOLEXIS S.P.A.) 25 Jul. 2007.

According to another preferred embodiment, the PFPE-PAGs are monofunctional PFPE-PAGs complying with formula (I-B) below:

A-O—R_{f}—CF₂—CH₂—O—Rₐ (I-B)

wherein:
A is a straight or branched C₁-C₄ perfluoroalkyl group wherein one fluorine atom can be substituted by one chlorine atom or one hydrogen atom, with the proviso that, if chlorine is present in group A, it is in a molar amount lower than 2% with respect to the overall amount of end groups,
Rₐ is as defined above and
R_{f} complies with formula (a) as defined above.

Preferred monofunctional PFPE-PAGs comprises 4 or from 6 to 50 chains Rₐ as defined above.

According to a preferred embodiment, monofunctional PFPE-PAGs for use according to the present invention have an average functionality (F) ranging from 1 to less than 1.50, preferably from 1 to 1.20.

In the method of the invention, bifunctional PFPE-PAGs of formula (I-A) are preferred.

### Methods for the Manufacture of the PFPE-PAGs of Formula (I)

The PFPE-PAGs for use in the method of the invention can be obtained by reaction of a mono- or bi-functional PFPE alcohol with an alkoxylating agent in such an amount as to obtain from 4 to 50, preferably from 4 to 30, more preferably from 4 to 15, oxyalkylene units at one or both chain ends.

For the purposes of the obtainment of the PFPE-PAGs of formula (I), the mono- or bi-functional PFPE alcohol complies with formula (II) below:

Y—O—R_{f}—(CF₂)ₓ—CFZ—CH₂—OH (II)

wherein:
R_{f}, x and Z are as defined above;
Y is (CF₂)ₓ—CFZ—CH₂—OH, wherein x and Z are as defined above, or is selected from straight or branched C₁-C₄ perfluoroalkyl groups wherein one fluorine atom can be substituted by one chlorine atom or one hydrogen atom, with the proviso that, if chlorine is present in group A, it is in a molar amount lower than 2% with respect to the overall amount of end groups and

the alkoxylating agent is selected from ethylene oxide, propylene oxide, 1,2-butylene oxide and styrene oxide and a mixture of two or more thereof.

Specifically, bifunctional PFPE-PAGs (I-A) wherein chain Rₐ complies with formula (Rₐ—I) as defined above wherein R¹ is hydrogen can be obtained by reaction of a bifunctional PFPE alcohol of formula (II-A) below:

HO—CH₂—CF₂—O—R_{f}—CF₂—CH₂—OH (II-A)

wherein R_{f} complies with formula (a) as defined above with ethylene oxide, propylene oxide, 1,2-butylene oxide, styrene oxide or with a mixture of two or more thereof.

Monofunctional PFPE-PAGs (I-B) wherein chain Rₐ complies with formula (Rₐ—I) as defined above wherein R¹ is hydrogen can instead be obtained by reaction of a monofunctional PFPE alcohol of formula (II-B) below:

A-O—R_{f}—CF₂—CH₂—OH (II-B)

wherein R_{f} complies with formula (a) as defined above and A is a straight or branched C₁-C₄ perfluoroalkyl group wherein one fluorine atom can be substituted by one chlorine atom or one hydrogen atom, with the proviso that, if chlorine is present in group A, it is in a molar amount lower than 2% with respect to the overall amount of end groups

with ethylene oxide, propylene oxide, 1,2-butylene oxide, styrene oxide or with a mixture of two or more thereof.

Mono- and bifunctional PFPE-PAGs wherein chain Rₐ complies with formula (Rₐ—I) in which R¹ is C₁-C₄-straight or branched alkyl can be obtained according to known methods by alkylation of the corresponding mono- and bifunctional PFPE-PAGs wherein chain Rₐ complies with formula (Rₐ—I) in which R¹ is hydrogen.

Mono- and bifunctional PFPE-PAGs wherein chain Rₐ complies with formula (Rₐ—I) in which R¹ is —C(O0)R² as defined above can be obtained according to known methods by acylation the corresponding mono- and bifunctional PFPE-PAGs wherein chain Rₐ complies with formula (Rₐ—I) in which R¹ is hydrogen.

PFPE alcohols of formula (II-A) or (II-B) can be manufactured by chemical reduction of corresponding PFPE carboxylic acids or esters according to several methods known in the art, using reducing agents such as NaBH₄, or by catalytic hydrogenation, as disclosed, for example, in U.S. Pat. No. 6,509,509 A (AUSIMONT S.P.A) 5 Jul. 2001, U.S. Pat. No. 6,573,411 (AUSIMONT S.P.A.) 21 Nov. 2002, WO 2008/122639 A (SOLVAY SOLEXIS S.P.A.) 16 Oct. 2008. Precursors of PFPE carboxylic acids or of PFPE esters can be manufactured according to different methods, e.g. by oxypolymerization of fluoroolefins or by ring opening polymerization of HFPO (hexafluoropropylene oxide), as taught in U.S. Pat. No. 3,847,978 A (MONTEDISON S.P.A.) 12 Nov. 1974, U.S. Pat. No. 3,766,251 A (MONTEDISON S.P.A.) 16 Oct. 1973, U.S. Pat. No. 3,715,378 A (MONTEDISON S.P.A.) 6 Feb. 1973, U.S. Pat. No. 3,665,041 (MONTEDISON S.P.A.) 23 May 1972, U.S. Pat. No. 4,647,413 A (MINNESOTA MINING & MFG) 3 Mar. 1987, EP 151877 A (MINNESOTA MINING & MFG) 21 Aug. 1985, U.S. Pat. No. 3,442,942 A (MONTEDISON S.P.A.) 6 May 1969, US 577291 A (MONTEDISON S.P.A.) 7 Jul. 1988, U.S. Pat. No. 5,258,110 A (AUSIMONT SRL) 2 Nov. 1993 or U.S. Pat. No. 7,132,574 (SOLVAY SOLEXIS SPA) 11 Jul. 2006.

Preferably, the PFPE-PAGs for use in the method of the invention present invention are synthesised following the process (or “method”) disclosed in international patent application WO 2014/090649 A (SOLVAY SPECIALTY POLYMERS ITALY S.P.A.) 19 Jun. 2014. This method comprises the use of a boron-based catalytic species, wherein sais species is prepared by first providing a mixture of a PFPE alcohol containing a catalytic amount of the corresponding alkoxide and then bringing into contact such mixture with a catalytic amount of a boric acid triester of the same PFPE alcohol.

In greater detail and with particular reference to the preparation of

PFPE-PAGs according to the invention, this process comprises the following steps:

1) separately providing a mixture [M1], comprising a PFPE alcohol of formula (II) as defined above and a catalytic amount of the corresponding alkoxide (herein after “PFPE-alk”);

2) bringing into contact mixture [M1] with a boric acid triester of the same PFPE alcohol (herein after “PFPE-triBor)” in such an amount that the molar ratio PFPE-alk:PFPE-triBor is at least 1, to obtain a mixture [M2];

3) contacting mixture [M2] with a catalytic amount of an iodine source to obtain a mixture [M3];

4) treating mixture [M3] with ethylene oxide, propylene oxide, 1,2-butylene oxide or styrene oxide or a mixture thereof to provide a mixture [M4] containing a PFPE-PAG (I).

In step 1) of the process, mixture [M1] is typically prepared by adding a base to the PFPE alcohol of formula (II) and by allowing the base to react with the PFPE alcohol and form a catalytic amount of the corresponding PFPE-alk dissolved in the PFPE alcohol. The base can be selected from metal hydrides or hydroxides like NaOH, KOH, Ca(OH)₂ and Mg(OH)₂; according to a preferred embodiment, the base is KOH. Typically, the base is used in such an amount to obtain from 1 to 15% , preferably from 2 to 12% of PFPE-alk with respect to the PFPE alcohol. Accordingly, for the purposes of the present description, the expression “catalytic amount of PFPE-alk” is intended to mean a molar amount ranging from 1 to 15% mol, more preferably from 2 to 12% mol with respect to the PFPE alcohol. When a metal hydroxide is used as base, the reaction is typically promoted by heating and the proceeding of the reaction is checked by monitoring the amount of water evaporated off the reaction mixture. When a metal hydride is used as base, the proceeding of the reaction is checked by monitoring the amount of hydrogen evaporated off the reaction mixture.

Step 2) can be performed in two different ways. In a first preferred embodiment, a mixture containing a PFPE-triBor and the PFPE alcohol (herein after referred to as mixture [Mₑₛₜ]) is prepared and then brought into contact with mixture [M1]. Typically, [Mₑₛₜ] is prepared by adding boric acid or a boric acid ester (including mono-, di- and tri-alkyl esters), and allowing the reagents to react until completion of the reaction, i.e. until obtainment of the PFPE-triBor in admixture with the PFPE alcohol. Typically, the esterification reaction is carried out under vacuum and with heating and the completion is checked by monitoring the amount of water (in case boric acid is used) or alcohol (in case an alkyl ester of boric acid is used) evaporated off the reaction mixture. In a second preferred embodiment, the PFPE-triBor is prepared in situ, i.e. by adding to [M1] a boric acid trialkyl ester as defined above; also in this case the reaction is typically carried out under vacuum and with heating and the completion of the reaction is checked in the same way. The molar ratio between the PFPE-alk and the PFPE-triBor is at least 1; according to a preferred embodiment, the PFPE-alk is used in excess with respect to PFPE-triBor, i.e. the molar ratio is higher than 1; still more preferably, the molar ratio is of at least 2. Indeed, it has been observed that when a molar ratio of at least 2 is used, the reaction proceeds faster and a higher conversion is achieved.

Step 3) of the process is typically carried out by adding a catalytic amount of an iodine source, to reaction mixture [M2]. The iodine source can be selected from one or more alkali- or alkaline-earth metal iodides, such as Nal, KI, CaI₂, ammonium iodides, such as NH₄I, elemental iodine and combinations thereof. According to a preferred embodiment, the iodine source is KI. A catalytic amount of iodine source is typically an equivalent amount ranging from 0.01 to 5% with respect to the fluoroalcohol.

Step 4) of the process is typically carried out by adding to mixture [M3] ethylene oxide, propylene oxide, 1,2-butylene oxide, styrene oxide or a mixture thereof in such a stoichiometric amount with respect to PFPE alcohol (II) as to obtain an alkoxylation degree ranging from 4 to 50, preferably from 4 to 15, more preferably from 4 to 10.

The alkoxylation reaction is typically carried out by adding to mixture [M3] one or more aliquots of ethylene oxide, propylene oxide or a mixture thereof and by monitoring the consumption of the oxide(s) and the formation of the PFPE-PAG. When ethylene oxide or propylene oxide is used, the reaction is monitored by checking the ethylene oxide pressure in the reactor. The reaction is typically carried out under heating at a temperature usually ranging from 90° C. to 190° C. When ethylene oxide is used as alkoxylating agent, the reaction is carried out at temperatures usually ranging from 110° to 160° C.

Once the reaction is complete, the resulting PFPE-PAG can be isolated from mixture [M4] by conventional techniques, including extraction and distillation. Usually, mixture [M4] is cooled down to room temperature and then diluted with a fluorinated solvent, then treated with a water solution of an inorganic base, typically a carbonate, and the organic phase is separated and submitted to distillation. Examples of fluorinated solvents include, for example, Galden® PFPEs, hydrofluoroethers (HFEs) including Novec® HFEs, hydrofluorocarbons (HFCs), like Vertel® or Fluorinert®, and fluoroaromatic solvents like hexafluorobenzene and 1,3-hexafluoroxylene. Typically, the fluorinated solvent is 1,3-hexafluoroxylene. Water-based lubricant compositions (C) comprising PFPE-PAGs of formula (I)

The PFPE-PAG of formula (I) are soluble in water, even in the absence of other surfactants. Therefore, they can be advantageously provided in the form of water-based compositions [compositions (C)] for use in the treatment of surfaces, in particular of surfaces to be lubricated. Furthermore, they have a lower coefficient of friction, lower wear and improved performances under extreme pressure conditions with respect to PAGs and they are stable under harsh conditions.

For the sake of clarity, for the purpose of the present invention a “water-based composition” is a composition comprising an amount of water typically higher than 10% , preferably ranging from 30% to 95.5% wt with respect to the weight of the composition.

Compositions (C) according to the present invention comprise:
at least one PFPE-PAG as of formula (I) as defined above and
water.

According to a preferred embodiment compositions (C) are free of surfactants.

Typically, compositions (C) comprise an amount of PFPE-PAG of formula

(I) as defined above ranging from 0.05% to 50% wt with respect to the weight of the composition, preferably from 3% to 30% wt, more preferably from 3% to 10% wt. In one preferred embodiment, compositions (C) consist of at least one PFPE-PAG as of formula (I) as defined above and water.

Nevertheless, compositions (C) according to the present invention may comprise at least one lubricant other than the at least one PFPE-PAGs of formula (I). Non limiting examples of such lubricant comprise PFPE base oils, polyalphaolefins (PAO), PAGs, mineral oils, silicon oils, polyphenylethers, polytetrafluoroethylene (PTFE), copolymers of tetrafluoroethylene and perfluoroalkyl ethers (MFA and PFA), polyvinylidene fluoride (PVDF), silica gel, water-born nanoparticles (e.g. MoS₂ nanoparticles), etc.

Non-limiting examples of PFPE lubricant base oils such as those disclosed in identified as compounds (1)-(8) in patent application EP 2100909 A (SOLVAY SOLEXIS SPA) Sep. 16, 2009.

According to one preferred embodiment, compositions (C) comprise at least one PFPE-PAG as of formula (I) as defined above, PTFE and water. These compositions can be conveniently obtained by a method that comprises adding aliquots of a PTFE aqueous colloidal dispersion to a PFPE-PAG as of formula (I). According to their PTFE content, the resulting compositions (C) can have a spreadable, grease-like consistency or they can be in the form of a sprayable milky suspension, so that they can be easily applied to the surfaces to be treated. Suitable PTFE aqueous colloidal dispersions that can be used for the manufacture of this preferred embodiment are marketed by Solvay Specialty Polymers Italy S.p.A. with tradename Algoflon® D.

If a composition (C) comprises at least one lubricant other than the at least one PFPE-PAGs of formula (I), or a further ingredient or additive typically used in lubricant compositions, an organic solvent and/or an ionic or non-ionic surfactant can be in included. Non-limiting examples of solvents are fluorinated or partially fluorinated solvents, such as Novec® HFEs, and other organic solvents like methyl-ethyl-ketone, isopropyl alcohol and butylacetate. In any case, the amount of solvent will be lower than the amount of water included in the composition. Preferably, the amount of organic solvent is not higher than 50% wt with respect to the weight of water.

Compositions (C) may also comprise further ingredients or additives typically used in lubricant compositions. Non-limiting examples of such ingredients or additives are antirust agents, antioxidants, thermal stabilizers, pour-point depressants, antiwear agents, including those for high pressures, tracers, dyestuffs, viscosity modifiers and antifoaming agents.

A further aspect of the present invention is a lubrication method comprising treating a surface with a composition (C) as defined above. For the sake of clarity, the surface to be lubricated can have any shape and can be made of any material that is chemically compatible with composition (C). Non-limiting examples of surfaces to be lubricated are polyamides, polycarbonates, polyesters, elastomers, metals, wood, polyoxymethyelene.

Composition (C) can be applied to a surface to be lubricated according to methods known in the art, for example by spraying, cast coating, dip coating, spin coating or die coating. A skilled person will select the most appropriate method according to the ingredients of compositions (C) and the nature of the surface to be lubricated.

Should the disclosure of any patents, patent applications and publications which are incorporated herein by reference conflict with the description of the present application to the extent that it may render a term unclear, the present description shall take precedence.

The invention will be herein after illustrated in greater detail by means of the Examples reported following experimental section.

### Experimental Section

### Material and Methods

The PFPE-PAG used in the Examples (herein after also referred to as “test PFPE-PAG”), complying with formula:

HO—(CH(CH₃)CH₂O)_{q}(CH₂CH₂O)ₚCH₂CF₂O(CF₂CF₂O)ₙ(CF₂O)ₘCF₂CH₂(OCH₂CH₂)ₚ(OCH₂CH(CH₃))_{q}—OH

with p=8.5 and q=4.5, m/n˜1, average number molecular weight Mn=2,900 and F=1.8

was manufactured according to the procedure disclosed in the aforementioned international patent application WO 2014/090649.

The PTFE latex (containing about 60% wt PTFE, 2.5% iso-tridecanol ethoxylate and water) used in Example 6 is marketed by Solvay Specialty Polymers Italy, S.p.A. with tradename Algoflon® D1614F.

Static and kinetic coefficients of friction of Plastic Film and Sheeting measurements were carried out according to ASTM D1894.

Viscosity Index VI was been calculated according to ASTM D2270 “Standard Practice for Calculating Viscosity Index from Kinematic Viscosity at 40 and 100° C.”

Kinematic viscosities at different temperatures were not experimentally measured, but they were calculated by means of the Ubbelohde-Walther equation in a temperature range from 20° C. to 100° C.

Wear on samples was evaluated according to ASTM D4172 “Standard Test Method for Wear Preventive Characteristics of Lubricating Fluids (Four-Ball Method)”, at 75° C., with a load of 40 Kgf (1200 rpm, 1 h).

Extreme pressure properties of lubricating oils for hydraulics, gears and engines under high-frequency linear oscillation motion were determined according to ASTM D7421 “Standard Test Method for Determining Extreme Pressure Properties of Lubricating Oils Using High-Frequency, Linear-Oscillation (SRV) Test Machine”.

The surface treatment of polycarbonates (PC) slabs was carried out as follows:

PC slabs having the sizes: 63.5 mm length×63.5 mm width were washed with EtOH (99.8% ) for 30′ in an ultrasound bath. Thereafter, they were dried for 30′ at room temperature. The slabs so prepared were sprayed with 25 ml of an aqueous solution containing the test PFPE-PAG (10 cross hands, nozzle nr. 25B). So, they are dried under vacuum at 60° C. for 2 hours and at end they are let for 24 h in a desiccator before the CoF test.

The NLGI grade was evaluated with the micropenetration method according to ASTM D217.

The CoF and the wear behaviour of the compositions obtained in Example 3 were measured with a SRV III optimol tribometer according to ASTM D 5707 method (Standard Test Method for Measuring Friction and Wear Properties of Lubricating Grease Using a High-Frequency, Linear-Oscillation Test Machine), under the following conditions: 200N, 80° C., duration: 2 hrs, stroke:1 mm.

### EXAMPLE 1

### Measurements of Kinematic Viscosity, Resistance to Wear and Resistance to Extreme Pressure of the Test PFPE-PAG

The tests were carried out as indicated in the “Material and Methods” section. The following results were obtained: Kinematic viscosity at 20° C.=2154 cSt, at 40° C.=622 cSt and at 100° C.=54 cSt, with a corresponding viscosity index equal to 148.

Wear on sample: the measured wear in the four-ball test was 0.48±0.04 mm.

The PFPE-PAG was also analysed under extreme pressure conditions according to the aforementioned ASTM D7421, under the following operative conditions:
temperature: 110° C. (kinematic viscosity of the sample oil at this temperature was 40 cSt);
stroke: 2 mm
frequency: 50 Hz
Pre-load: 50 N for 30″
Load: 100 N for 15′ and increase of 100 N each 2′ up to 2000 N.

The results showed that no seizure occurred at the final load of 2000 N.

### EXAMPLE 2

### Stability of a Water Solution of a PFPE-PAG and Evaluation of the Coefficient of Friction

A solution at 5% by wt. in water was prepared by stirring 25 g of the test PFPE-PAG in 475 g of water. After stirring, the solution appeared clear and transparent. No sediments or phase separation was observed (t=0 clear 1 phase; checked also at t=24 h clear 1 phase and t=120 h clear 1 phase).

This solution was sprayed onto polycarbonate slabs, according to the procedure described above.

A Coefficient of Friction (CoF) test according to ASTM D1894 was carried out and provided the following results:
Static CoF =0.106±0.004
Dynamic CoF =0.099±0.034

### EXAMPLE 3

### Comparative Example

Example 2 was repeated using pure water only (100% water). The following results were obtained:
Static CoF=0.172±0.084
Dynamic CoF=0.175±0.099

Example 2 demonstrates that the PFPE-PAG is completely soluble in water without using any other surfactant.

A comparison between Example 2 and Example 3 demonstrated that a very thin film of a PFPE-PAG according to the present invention was deposited and that it strongly reduced the CoF of the treated plastic of about 40% with respect to untreated plastic.

### EXAMPLE 4

### Measurement of the CoF on Polycarbonate Slabs Coated with a PFPE-PAG

A solution at 10% by wt. in water and isopropyl alcohol was prepared by stirring 50 g of the test PFPE-PAG in 445 g water and 5 g isopropyl alcohol. After stirring, the solution appeared clear and transparent. No sediments or phase separation was observed (t =0 clear 1 phase; checked also at t=24 h clear 1 phase and t=120 h clear 1 phase).

Polycarbonate slabs, prepared according to the procedure described above, were dipped into the solution.

A Coefficient of Friction (CoF) test according to ASTM D1894 was carried out and provided the following results:
static CoF=0.155±0.032;
dynamic CoF=0.049±0.013

### EXAMPLE 5

### Comparative Example

### Measurement of the CoF on polycarbonate slabs coated with a polyoxyalkylene glycol

A solution at 10% by wt. in water and isopropyl alcohol was prepared by stirring 50 g of polyoxyalkylene glycol PEG 2000 (Sigma Aldrich) in 445 g water and 5 g isopropyl alcohol. After stirring, the solution appeared clear and transparent. No sediments or phase separation was observed (t=0 clear 1 phase; checked also at t=24 h clear 1 phase and t=120 h clear 1 phase).

Polycarbonate slabs, prepared according to the procedure described above were dipped into the solution.

A Coefficient of Friction (CoF) test according to ASTM D1894 was carried out and provided the following results:
static CoF=0.352±0.238
dynamic CoF=0.191±0.111

It stems from Examples 4 and 5 that the PFPE-PAG used in accordance with the invention has a remarkably lower CoF than a polyoxyalkylene glycol.

### EXAMPLE 6

### Preparation of a Water-Based Composition Comprising a PFPE-PAG and a PTFE Latex

Aliquots of Algoflon® D1614F PTFE aqueous colloidal dispersion (total amount 15 g) were added to 36 g of the test PFPE-PAG contained in a beaker, under magnetic stirring on a hotplate, at the temperature of 50° C.; a grease-like composition was obtained.

The measured NLGI grade of the composition was 3, while the CoF and friction test gave the following results:

CoF_{end}=0.119 (coefficient of friction at the end of the test)

Wear (mm) 1.08±0.04.

It was observed that the CoF remained constant during at values ranging from 0.10 to 0.13.

1. A composition comprising:
at least one polymer (P) comprising a partially or fully fluorinated, straight or branched, polyoxyalkylene chain (R_{f}) having two chain ends, wherein one or both chain end(s) bear(s) a hydroxy-, alkoxy- or acyloxy-terminated polyoxyalkylene chain free from fluorine atoms (Rₐ), said chain comprising from 4 to 50 fluorine-free oxyalkylene units, said units being the same or different from one another and being selected from —CH₂CH₂O— and —CH₂CH(J)O—, wherein J is independently straight or branched alkyl or aryl, and
water.

2. The composition according to claim 1 wherein polymer (P) complies with formula (I) below:
A-O—R_{f}—(CF₂)ₓ—CFZ—CH₂—O—Rₐ (I)
wherein:
R_{f} is a (per)fluoropolyoxyalkylene chain having an average number molecular weight Mₙ ranging from 100 to 8,000 and comprising repeating units, which may be equal to or different from one another, selected from:
(i) —CFXO—, wherein X is F or CF₃,
(ii) —CFXCFXO—, wherein X, equal or different at each occurrence, is F or CF₃, with the proviso that at least one of X is F;
(iii) —CF₂CF₂CW₂O—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —OR_{f}′T, wherein R_{f}′ is a fluoropolyoxyalkene chain comprising a number of repeating units from 0 to 10, said recurring units being selected from chosen among the followings: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl
Z is fluorine or CF₃;
x is 0 or 1, with the proviso that, when x is 1, Z is F;
A is —(CF₂)ₓ—CFZ—CH₂—O—Rₐ, wherein x and Z are as defined above, or is a straight or branched C₁-C₄ perfluoroalkyl group wherein one fluorine atom is optionally can be substituted by one chlorine atom or one hydrogen atom, with the proviso that, if chlorine is present in group A, it is in a molar amount lower than 2% with respect to the overall amount of end groups and
Rₐ is a hydroxy-, alkoxy- or acyloxy-terminated polyoxyalkylene chain free from fluorine atoms (chain Rₐ), said chain comprising from 4 to 50 fluorine-free oxyalkylene units, said units being the same or different from one another and being selected from —CH₂CH₂O— and —CH₂CH(J)O—, wherein J is as defined in claim 1.

3. The composition according to claim 1, wherein chain R_{f} in polymer (P) is selected from formulae (a)-(c) here below:
(CF₂O)ₙCF₂CF₂O)ₘ(CF₂CF₂CF₂O)ₚ(CF₂CF₂CF₂CF₂O)_{q}— (a)
wherein m, n, p, q are selected from 0 and integers such that chain R_{f} meets the above number average molecular weight requirement;
—(CF₂CF(CF₃)O)ₐ(CF₂CF₂O)_{b}(CF₂O)_{c}(CF(CF₃)O)_{d}— (b)
wherein a, b, c, d are selected from 0 and integers selected such that chain R_{f} meets the above number average molecular weight requirement; with the proviso that, at least one of a, c and d is not 0;
—(CF₂CF(CF₃)O)ₑ(CF₂O)_{f}(CF(CF₃)O)_{g}— (c)
wherein e, f, g are selected from 0 and integers such that chain R_{f} meets the above number average molecular weight requirement.

4. The composition according to claim 3, wherein chain R_{f} in polymer (P) complies with formula (a).

5. The composition according to claim 1 wherein chain Rₐ in polymer (P) complies with formula (Rₐ—I) below:
(Rₐ—I)—(CH₂CH₂O)ᵣ(CH₂CH(CH₃)O)ₛ(CH₂CH(CH₂CH₃)O)ₜ(CH₂CH(Ph)O)ₙR¹
wherein r, s, t and u are independently selected from 0 and a positive number, with r+s+t+u ranging from 4 to 50, and R¹ is selected from hydrogen, C₁-C₄ straight or branched alkyl, and —C(O)R², wherein R² is C₁-C₄ straight or branched (halo)alkyl.

6. The composition according to claim 5 wherein in chain (Rₐ—I), r is a positive number ranging from 4 to 15, s, t and u are 0 and R¹ is hydrogen or methyl.

7. The composition according to claim 5 wherein, in chain (Rₐ—I), r, t and u are 0, s is a positive number ranging from 4 to 15 and R¹ is hydrogen or methyl.

8. The composition according to claim 5 wherein in chain (Rₐ—I), t and u are 0, r+s ranges from 4 to 15 and R¹ is hydrogen or methyl.

9. The composition according to claim 2, wherein polymer (P) complies with formula (I-A) below:
Rₐ—O—CH₂—CF₂—O—R_{f}—CF₂—CH₂—O—Rₐ (I-A)
wherein:
Rₐ is as defined in claim 2 and
R_{f} complies with formula (a);
—(CF₂O)ₙ(CF₂CF₂O)ₘ(CF₂CF₂CF₂)ₙ(CF₂CF₂CF₂CF₂O)ₙ— (a)
wherein m, n, p, q are selected from 0 and integers such that chain R_{f} meets the above number average molecular weight requirement.

10. The composition of claim 1 which is free of surfactants.

11. The composition of claim 1 further comprising polytetrafluoroethylene.

12. A method of treating a surface which comprises applying the composition of claim 1, to the surface.

13. A method for the manufacture of a composition according to claim 11 which comprises adding a polytetrafluoroethylene aqueous colloidal dispersion to a polymer (P), wherein polymer (P) comprises a partially or fully fluorinated, straight or branched, polyoxyalkylene chain (R) having two chain ends, wherein one or both chain end(s) bear(s) a hydroxy-, alkoxy- or acyloxy- terminated polyoxyalkylene chain free from fluorine atoms (Rₐ), said chain comprising from 4 to 50 fluorine-free oxyalkylene units, said units being the same or different from one another and being selected from —CH₂CH₂O— and —CH₂CH(J)O—, wherein J is independently straight or branched alkyl or aryl.

14. The composition according to claim 1, wherein each occurrence of J is independently selected from methyl, ethyl and phenyl.

15. The composition according to claim 2, wherein R_{f} has an average number molecular weight Mₙ ranging from 300 to 6,000,

16. The composition according to claim 2, wherein R_{f} has an average number molecular weight Mₙ ranging from 800 to 3,000.

17. The composition according to claim 3, wherein:
(a) when m is other than 0, the m/n ratio is between 0.1 and 20 and when (m+n) is other than 0, (p+q)/(m+n) is between 0 and 0.2;
(b) when b is other than 0, a/b is between 0.1 and 10 and when (a+b) is different from 0 (c+d)/(a+b) is between 0.01 and 0.5; and
(c) when e is other than 0, (f+g)/e is between 0.01 and 0.5.

18. The composition according to claim 5, wherein r+s+t+u ranges from 4 to 15.

19. The composition according to claim 9, wherein, when m is other than 0, the m/n ratio is between 0.1 and 20 and wherein when (m+n) is other than 0, (p+q)/(m+n) is between 0 and 0.2.
